(19) United States
(12) Patent Application Publication
(10) Pub. No.: US 2021/0070324 A1
(43) Pub. Date: Mar. 11, 2021

(54) APPARATUS, SYSTEM, AND METHOD FOR ESTABLISHING AND MAINTAINING WIRELESS COMMUNICATION IN SIGNAL DEPRIVED ENVIRONMENTS

(71) Applicant: ShadowTech Labs, Willowbrook, IL (US)

(72) Inventors: David Nahlik, Chicago, IL (US); Michael Collins, Chicago, IL (US); Dennis Collins, Park Ridge, IL (US)

(21) Appl. No.: 17/017,116

(22) Filed: Sep. 10, 2020

Related U.S. Application Data
(60) Provisional application No. 62/898,412, filed on Sep. 10, 2019.

(51) Int. Cl. B60W 60/00; G05D 1/02; H04B 17/327; H04B 17/336; G05D 1/00

(52) U.S. Cl. CPC B60W 60/00256; G05D 1/0242; G05D 1/0246; B60W 2300/12; H04B 17/336; G05D 1/0022; B60W 2756/10; H04B 17/327

(57) ABSTRACT

An apparatus, system, and method for establishing a communications network include a remote-control vehicle configured for wireless communication and a plurality of wireless communication devices carried by a part of the remote-control vehicle. The remote-control vehicle is configured to selectively eject or dispense the plurality of communication devices as deployed devices within a signal deprived environment. Each deployed device is capable of wireless communication with the remote-control vehicle and with one or more other of the deployed devices. Each deployed device and the remote-control vehicle are configured to define a part of the communicate network with a control unit disposed at a distance from the remote-control vehicle

### RELATED APPLICATION DATA

This patent is entitled to the benefit of and claims priority to co-pending U.S. Provisional Application Ser. No. 62/898,412 filed Sep. 10, 2019 and entitled “Apparatus, System, and Method for Establishing and Maintaining Wireless Communication in Signal Deprived Environments.” The entire contents of this prior filed application are hereby incorporated herein by reference.

### BACKGROUND

### 1. Field of the Disclosure

The present disclosure is generally directed to clearing and search operations in high danger and signal deprived environments, and more particularly to an apparatus, system, and method for establishing and maintaining wireless communication in such environments.

### 2. Description of Related Art

Improvised Explosive Devices (IEDs) are used extensively throughout the world by terrorists, drug cartels, hostile military units, and the like IEDs are an inexpensive, low-tech method used to raise apprehension and inflict causalities in personnel and to damage equipment. Numerous solutions have been devised and implemented for detecting and disarming such IEDs, which may be found on or beside roads, in or near buildings, in tunnels and caves, in marine vessels, or contained in vehicles. Such solutions have been fielded and deployed with varying degrees of success.

Conducting clearing and search operations for such IEDs and other dangers within signal deprived environments, such as caves, tunnels, bunkers, ships, buildings, and the like has been a long-standing problem for operators in high-risk environments. Adequate equipment is lacking for systems that are used to search and/or clear tunnels and caves of booby traps and armed hostile personnel. Traditional methodologies have included both human and machine, i.e., robot clearing and/or search options. Placing human operators in harm's way (i.e., entering confined spaces or uncleared areas) is never an optimal option. Remotely operated systems have thus been developed to alleviate such risks to personnel. However, remotely operated solutions have too often proven unreliable. This has forced human operators into danger zones to recover failed remotely controlled systems or to manually continue clearing and/or search missions.

Remote system options include operating a robot and directing the robot into signal deprived and high danger or high-risk environments. Remote system options can be broken down into two (2) broad types: tethered systems and radio-controlled systems. Both options have advantages and disadvantages. These options are discussed briefly below.

A tethered system deploys a remotely controlled unit that is physically connected to a control or head end unit for power and communication. Tethered systems rely on a cable trailing the remote-controlled vehicle or unit, which carries other system devices. The cable provides power, control, and sensor and device interface for video assessment, infra-red sensors, voice communications, and the like. When used in a clean environment, the tethered systems generally have proven to be an acceptable option. However, when used in caves, ships, other difficult environments, or in battle-damaged or ongoing battle areas, the tethered system has proven to be inadequate. The cable is a liability because it tends to snag or hang up on objects within the environment. Also, the cable has a finite length, which limits the functional range of such a system.

In a tethered system, if the cable is too short, the operator may need to enter the cave, tunnel, or other confined space along with the remote unit. The detonation of an IED or engagement with hostile personnel could result in catastrophic damage to friendly forces tasked with the clearing and/or searching operations. For example, forces within the blast zone would be rendered combat ineffective or possibly killed as a result of an unplanned detonation. If the tether becomes snagged or hung up on an object, the remote unit may not be able to proceed forward or to be retrieved by remote control.

A radio-controlled system (RCS), unlike the tethered system, relies on a radio transmitter/receiver located at both the head end control unit and the remotely controlled unit. The radio allows the controller to communicate with the remotely controlled unit and to monitor data, audio communications, and video over a radio frequency (RF). However, caves, tunnels, bunkers, ships, and other such areas create signal deprived pockets and environments where the ability to communicate with or along the RCS is greatly reduced by distance, corners, elevation changes, and other RF obstructions. An RCS basically depends on line-of-sight for reliable operation. These signal deprived areas present point-to-point radio communication limitations, which frustrates command, control, communication, and computer (C4) abilities. The ability to communicate is reduced or lost as the radio remote-controlled vehicle or unit of the RCS loses line of sight with the controller or operator and thus loses communication with the head end or control unit.

Tunnels, caves, and other such areas rarely provide a RF friendly environment. Increases or decreases in elevation and curves, twists, and turns become signal deprived or signal denial zones. For the robot unit or remote-controlled device to maintain communications with the control unit, the operator is forced to move into the confined space or dangerous zone to continue communications.

Currently employed solution sets are also expensive, require significant manpower, consume high power, and require highly skilled operation. Some systems rely on a fixed network of transmission stations, i.e., a mesh network, which employs fixed position or stationary communication nodes or devices. Most solutions for signal deprived environments, however, rely on mobile ad hoc network (MANET) radios. These systems rarely allow for high bandwidth operations and can cost upwards of $15,000 per radio or communication unit. These systems also require extensive, expensive training and high levels of power. It is also often standard operating procedure (SOP) to leave personnel in place to operate and/or protect these relays, which is costly in usurping valuable manpower and resources.

### Summary

In one example, according to the teachings of the present disclosure, an apparatus for establishing a communications network includes a remote-control vehicle configured for wireless communication and a plurality of wireless communication devices carried by a part of the remote-control vehicle. The remote-control vehicle is configured to selectively eject or dispense the plurality of communication devices as deployed devices within a signal deprived environment. Each deployed device is capable of wireless communication with the remote-control vehicle and with one or more other of the deployed devices. Each deployed device and the remote-control vehicle are configured to define a part of the communicate network with a control unit disposed at a distance from the remote-control vehicle.

In one example, the apparatus can further include a dispensing device on the remote-control vehicle. The dispensing device can be configured to hold and/or selectively eject or dispense the plurality of wireless communication devices.

In one example of the apparatus, the remote-control vehicle or a dispensing device can include a magazine holding the plurality of wireless communication devices.

In one example of the apparatus, a spent magazine can be replaced on the remote-control vehicle with a pre-loaded magazine loaded with a plurality of wireless communication devices.

In one example of the apparatus, a spent magazine can be reloaded on the remote-control vehicle with a plurality of wireless communication devices.

In one example of the apparatus, the remote-control vehicle can be equipped with one or more of video communication capability, audio communication capability, sensor capability, light emitting capability, and/or infra-red illumination or video capability.

In one example of the apparatus, each deployed device of the plurality of wireless communication devices can be configured to automatically activate when ejected or dispensed from the remote-control vehicle.

In one example, according to the teachings of the present disclosure, a system for establishing and maintaining a communications network includes a control unit operated from a base location in or near a signal deprived environment, a remote-control vehicle operable by wireless communication with the control unit within the signal deprived environment, and a plurality of wireless communication devices carried by a part of the remote-control vehicle. Each of the plurality of wireless communication devices can be selectively ejected or dispensed as a deployed device within the signal deprived environment from the remote-control vehicle through wireless communication with the control unit. The communications network is established and/or maintained between the control unit and the remote-control vehicle through any one or more of the deployed devices of the plurality of wireless communication devices.

In one example of the system, each of the deployed devices of the plurality of wireless communication devices can automatically activate when ejected or dispensed from the remote-control vehicle.

In one example, the system can further include a dispensing device on the remote-control vehicle. The dispensing device can be configured to hold and/or selectively eject or dispense the plurality of wireless communication devices.

In one example of the system, the remote-control vehicle or the dispensing device can include a magazine holding the plurality of wireless communication devices.

In one example of the system, a spent magazine can be replaced on the remote-control vehicle with a pre-loaded magazine that is loaded with a plurality of the wireless communication devices.

In one example of the system, a spent magazine can be reloaded on the remote-control vehicle with a plurality of wireless communication devices.

In one example of the system, the remote-control vehicle can be equipped with one or more of video communication capability, audio communication capability, sensor capability, light emitting capability, and/or infra-red illumination or video capability.

In one example of the system, the remote-control vehicle can be configured to eject or dispense one of the wireless communication devices before or when it is detected that a signal between the control unit and the remote-control vehicle falls to or below a minimum signal strength threshold.

In one example of the system, the signal reduction can be determined based on monitoring Signal-to-Noise Ratio (SNR), signal strength, signal bandwidth, Radio Signal Strength Indicator (RSSI), or any combination thereof.

In one example, according to the teachings of the present disclosure, a method for establishing and maintaining a communications network includes: operating, from a control unit, a remote-control vehicle or unit, into a signal deprived environment; monitoring signal strength between the control unit and the remote-control vehicle or unit; before or upon detection of a signal reduction to or below a minimum signal strength threshold, ejecting or dispensing, by the remote-control vehicle, a wireless communication device within the signal deprived environment; and further operating the remote-control vehicle or unit into the signal deprived environment.

In one example, the method can further include repeating, one or more times, the steps of monitoring, ejecting or dispensing, and further operating.

In one example of the method, the signal reduction can be determined based on monitoring Signal-to-Noise Ratio (SNR), signal strength, signal bandwidth, Radio Signal Strength Indicator (RSSI), or any combination thereof.

### BRIEF DESCRIPTION OF THE DRAWINGS

The drawings provided herewith illustrate one or more examples or embodiments of the disclosure and therefore should not be considered as limiting the scope of the disclosure. There may be other examples and embodiments that may be equally effective to achieve the objectives and that may fall within the scope of the disclosure. Objects, features, and advantages of the present invention will become apparent upon reading the following description in conjunction with the drawing figures, in which:

FIG. 1 shows a simplified schematic of one example of a system in accordance with the teachings of the present disclosure and configured to establish and maintain wireless communication within signal deprived environments.

FIG. 2 shows a perspective view of one example of a remote-control vehicle constructed in accordance with the teachings of the present disclosure.

FIG. 3 shows a perspective view of one example of a wireless communication device in accordance with the teachings of the present disclosure and in a deployed and activated state.

FIG. 4 shows a simplified cross-section view of one example of an automated dispenser in accordance with the teachings of the present disclosure and for selectively dispensing the wireless communication devices of FIG. 4.

FIG. 5 shows a schematic view of one example of a communications network established using the components of FIGS. 1-4.

FIG. 6 shows a flow chart of one example of a method of establishing a communications network in accordance with the teachings of the present disclosure.

The use of the same reference numbers or characters throughout the description and drawings indicates similar or identical components, aspects, and features of the disclosure.

### DETAILED DESCRIPTION OF THE DISCLOSURE

The disclosed apparatus, system, and method solve or improve upon one or more of the above-noted and/or other problems and disadvantages with prior known systems and solutions. The disclosed apparatus is controllable by wireless communication to navigate a signal deprived environment. The disclosed apparatus is also controllable to deploy wireless communication devices, as needed, throughout the signal deprived environment to establish a communications network within such an environment. The disclosed system allows an operator to operate a remote-control vehicle within a signal deprived environment to maneuver the vehicle and to utilize the various on-board vehicle systems and functions. The disclosed method allows an operator to inspect and investigate a signal deprived environment with a remote-control vehicle by establishing a communications network utilizing the remote-control vehicle and deployable wireless communication devices within the environment. These and other objects, features, and advantages will become apparent to those having ordinary skill in the art upon reading this disclosure.

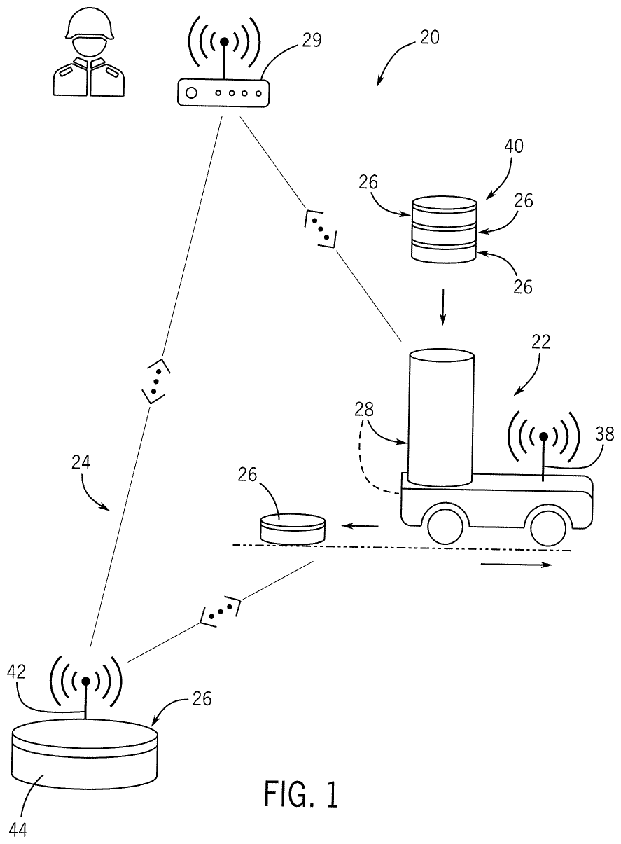

Turning now to the drawings, FIG. 1 shows a generic schematic of a communications network and system constructed and configured according to the teachings of the present disclosure. In one example, an apparatus, a system that utilizes the apparatus, and a method that utilizes the system and apparatus, are disclosed and described herein according to the teachings of the present disclosure. The apparatus, system, and method are collectively referred to herein as the Tunnel Rat (the apparatus), the Tunnel Rat system, or the Tunnel Rat method for ease of description. The Tunnel Rat system 20 is generally configured to establish and maintain wireless communication within signal deprived environments. The Tunnel Rat system 20, more specifically, establishes and maintains a flexible and expandable wireless communications network to enable remote vehicle, and sensor and electronic component suite, operation deep into high risk, signal-deprived, subterranean, and other environments. The Tunnel Rat system 20 provides operators with the capability to conduct clearing and/or search operations within such signal deprived environments and vastly improves safety, reliability, and effectiveness in comparison to existing systems and methods.

In one example, the Tunnel Rat system 20 is composed of multiple primary components or sub-systems. One element or sub-system is a remote-controlled vehicle 22 or unit, i.e., the Tunnel Rat or Tunnel Rat vehicle (TRV). Another element or sub-system is a secure wireless communications network, i.e., the network 24. Yet another element or sub-system is a plurality of wireless communication devices 26, i.e., the Tunnel Rat communication pucks (TRCPs). Still another element or sub-system is an automated dispensing device 28 for dispensing the TRCPs 26, i.e., the Automated Puck Dispenser (APD). Yet another element or sub-system is a main control unit or controller 29, controlled by an operator, to operate the TRV 22 and the system and network. These components allow the operator to create an adaptable and expandable communication system.

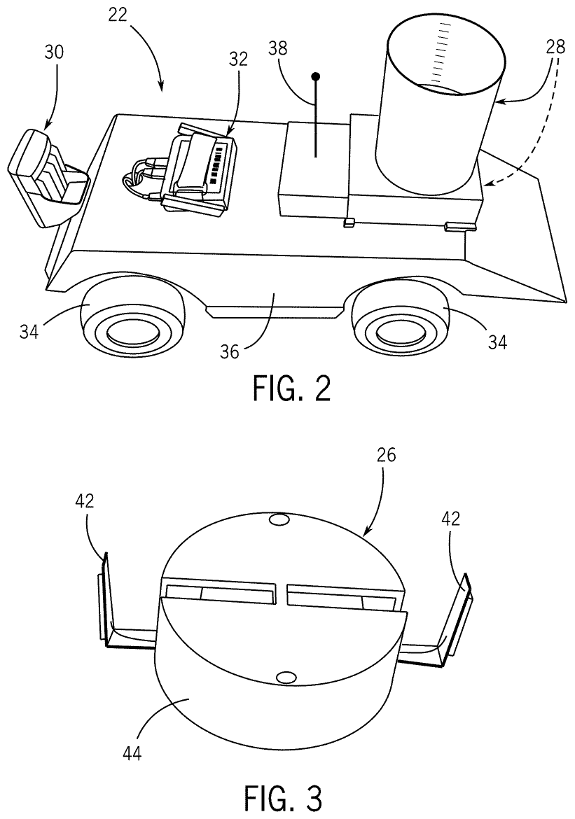

FIGS. 1 and 2 show generic examples of the TRV 22, which is a remotely operated, radio-controlled robotic vehicle. The TRV 22 can provide the tactical warfighter or operator with intelligent reconnaissance deep into signal-deprived environments such as sub-terranean areas, tunnels, caves, bunkers, ships, and the like. The TRV 22 can be equipped with various on-board electronic equipment and components 30 and 32. The equipment and components 30 can be configured to provide high-definition video, IR illumination, motion sensor analytics, two-way data communications, and two-way communications for voice/audio/sound. Thus, the TRV 22 can provide video images, audio data, various sensor data, and the like from the location of the TRV. Likewise, the TRV 22 can provide or deliver various electronic and other functions at the location of the TRV, including sound or audio, electronic signals, illumination, and the like. The equipment and components 30 can also include one or more separate processors, as needed, to impart desired functionality to the electronic features and functions of the equipment, components, system, and network. The electronic component 32 can include a wireless transceiver for wirelessly communicating with the network, as it is established, and can include a processor for also providing on-board functionality and features for the TRV and the network.

The TRV 22 can run on a battery (not shown) for continuous operation. The battery type, size, and life can be varied, depending on the needs of a given operation or system purpose. The life or run time duration of the battery can vary depending on the battery characteristics. In one example, the battery can provide at least two (2) hour of continuous operation for the TRV 22 and the on-board electronic components and equipment 30, 32, and their respective functions.

The TRV 22 can include a motor (not shown) and wheels 34, tracks, or the like to permit the TRV to be driven to and throughout a desired area or environment. In another example, the TRV can be a different type of vehicle or remote-control unit, such as a floating or submergible vehicle for water-borne operations or a drone for airborne operations, if desired. The size, shape, and configuration of the TRV 22 can vary considerably within the scope and spirit of the present disclosure. The TRV 22 can include a body 38, which can be lightweight, if desired. The wheels 34 can be solid or air-filled, can vary in size, can be formed of various materials, such as rubber or composite, and can have different types of rolling surfaces, such as treads or the like. The body 36 or shell of the TRV 22, as well as the wheels 34, can be formed of any suitable materials, but in one example can be configured to resist damage from projectiles, shrapnel, explosives, and the like. The TRV 22 can also include, as noted above, one or more on-board processors and/or printed circuit boards (PCBs) to provide and control the various electronic devices and components 30, 32, and capabilities of the TRV. The TRV 22 can also include an internal antenna or a deployed or extended antenna 38 to enhance signal strength and reception.

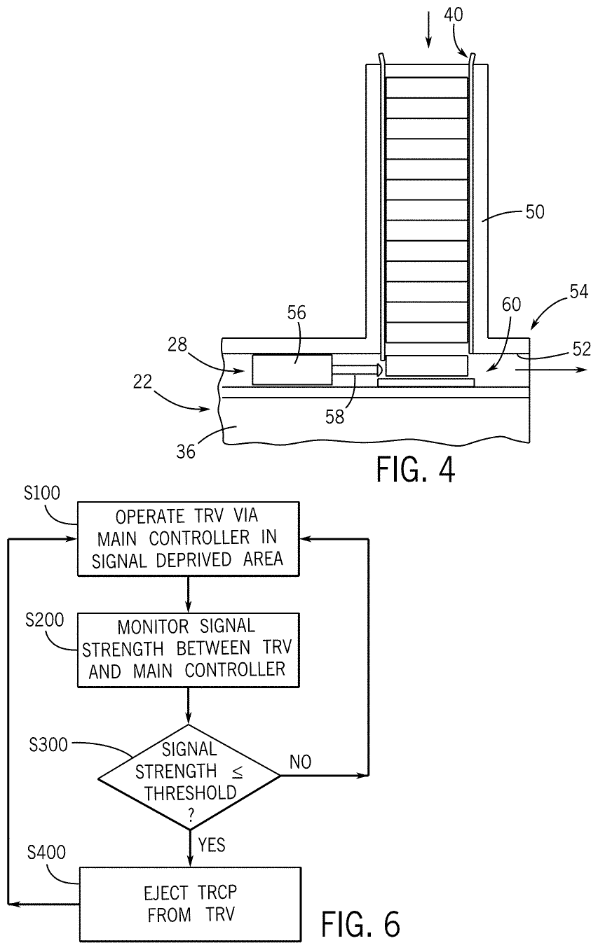

Referring to FIGS. 1 and 3, the TRCPs 26 can be small electronic communication devices, such as pods, pucks, nodes, or the like. The TRCPs 26 can be self-actuating, i.e., be activated or turned on, upon being ejected or dispensed from the APD 28. The TRCPs 26 can also be self-joining or self-connecting to the network. Thus, once ejected or dispensed, each deployed TRCP 26 can automatically join or connect to the network that includes the main controller 29 and the TRV 22. The TRCPs 26 can be small and have a low profile to render them unobtrusive and inconspicuous. The TRCPs 26 can each also include a small on-board power source, such as a battery. The TRCPs 26 can be configured for low power operation in that their only function may be to provide network continuity. Each TRCP 26 can thus also have the minimal requisite on-board electronics necessary to send and receive signals over the network. The TRCPs 26 can include a battery that may provide a predetermined life, such as a minimum of eight (8) hours on battery power. In one example, as discussed further below, the Tunnel Rat or TRV 22, or the APD 28, can carry a cartridge or magazine 40 of the TRCPs 26 as it travels into the signal deprived area (see FIGS. 2 and 4).

In one example as shown in FIG. 3, each TRCP 26 can have one or more on-board antennas 42. The antenna or antennas 42 can be connected to a PCB, transceiver, processor, and/or the like disposed within a case 44 or housing of the TRCP. The antennas 42 can be internal to the TRCP body or can be deployed or deployable from the case 44, as shown in FIG. 3. In one example, the antennas 42 can auto deploy once the TRCP 26 is ejected or dispensed from the TRV 22. FIG. 3 illustrates one example of a TRCP 26 with two antennas 42 that automatically rotate or pivot from the case 44 when deployed from the APD 28. The antennas 42 may be pressure activated.

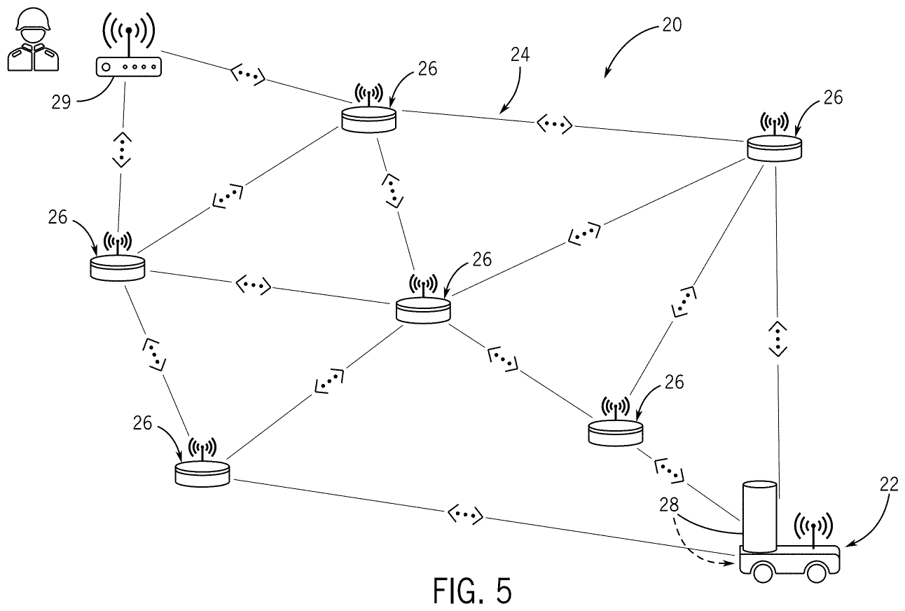

Each TRCP 26 may be configured to provide self-forming and self-healing features. Accordingly, the TRCPs 26 can be configured to communicate with one another and with the TRV 22 and/or the controller 29 to bypass any single failure point, such as a dead or malfunctioning TRCP 26 (see FIG. 5). The TRCPs 26 can be configured to be relatively low-cost, expendable communication devices that can create and expand the reach of the network. The case 44 or housing of the TRCPs 26 can be made from a material of having a structure that is impact resistant, strong, and durable, if desired. The TRCPs 26 can be deployed throughout the signal deprived area to ensure continuous communication and control of the TRV 22 from the controller 29 for streaming of high definition video, data, voice, and other functions. The TRCPs 26 can be compatible with existing IP tactical radios, such as HARRIS FALCON III® AN/PRC-152A, TrellisWare, Persistent Systems, Silvus, and the like, via ethernet tether linking.

Referring to FIGS. 1, 2, and 4, the APD 28 can be combined with the cartridge or magazine 40 or can be a separate part of the TRV 22. In one example, the magazine 40 is configured to contain or be loaded with a plurality of the TRCPs 26. The APD 28 may be, may include, or may be coupled to an easily replaceable cartridge or magazine 40 on the TRV 22. In one example, the TRCPs 26 may be loaded into a magazine or cartridge 40 and then the magazine or cartridge may be inserted into a dispenser or housing part of the APD 28 or otherwise attached to the APD or the body of the TRV 22. As the TRV 22 moves through an area to be cleared or searched, all communications with the head end controller 29, i.e., the control unit, can be monitored via the network, as described below.

FIG. 4 shows just one simplified example, of many possible examples, of an ADP 28 and magazine 40 arrangement for the TRV 22. In this example, the body 36 of the TRV 22 includes a receiver stack 50 configured to removably receive a magazine 40 of TRCPs 26 through a top opening of the stack. In this example, the ADP 28 is a mechanism that is configured as a part of the TRV 22. The ADP 28 cooperates with the receiver stack 50 and the magazine 40 to eject a TRCP 26 through an opening 52 at a rear end 54 of the TRV 22. In this example, the ADP 28 can be an electromechanical device or mechanism 56 configured to communicate with the network and the main controller 29. The ADP 28 can also have an ejector 58 that is actuated by the mechanism 56 upon receiving the signal or instructions to eject or dispense a TRCP 26. The magazine 40 may gravity feed or spring feed the loaded TRCPs 26 downward toward the ejector 58. A chute 60 may be aligned with the lowermost TRCP 26, the ejector 58, and the opening 52 in the body 36.

In other examples, the magazine or TRCP stack may be horizontally oriented or may be oriented and stored in different configurations. The TRCPs may also be dropped vertically downward from the TRV or at an angle between vertical and horizontal from the TRV. Further, the Ejector 58 may be replaced by a gate or trap door that blocks or releases a TRCP upon being actuated. Further, all or at least part of the ADP 28 may be part of the removable magazine or cartridge and not a part of the TRV 22. Instead, a connector may connect the ADP to the electronics on board the TRV when the magazine or cartridge is installed on the TRV. Other examples and arrangements, and other mechanisms and components may be utilized as the ADP 28 or as a part of the ADP 28 within the spirit and scope of the present disclosure.

As needed, TRCPs 26 can be dispensed manually by the operator or automatically. In one example, as discussed further below, the TRCPs 26 can be auto ejected when communication strength reaches or falls below a predetermined minimum level, based on a bandwidth and/or signal strength threshold. In another example, the TRCPs 26 can also be deployed manually by the operator from the head end controller 29 or control unit based on the same signal strength threshold or at otherwise desirable locations to assure optimal signal strength and quality.

The TRCPs 26 can be loaded in a rapid mounting magazine or cartridge in the APD 28 or on the TRCP 22, may be loaded directly into the APD, or may be pre-loaded into a magazine or cartridge that is then installed in or coupled to the APD. The APD 28 may be capable of mounting to a standard U.S. military mounting unit or a similar mount. The APD 28 may be configured as a part of a uniquely design TRV 22 with an integrated APD 28 or can be configured to be adapted to existing radio-controlled vehicles or units. The APD 28 can be configured such that the TRCPs 26 are separately and automatically ejected from the APD, based on signal monitoring presets, such as a Signal-to-Noise Ratio (SNR) measurement or threshold or the like. In one example, the TRCPs 26 can be ejected or dispensed directly below the TRV 22 and/or the APD 28. Alternatively, as represented in FIG. 1, the TRCPs 26 can be ejected or dispensed rearward, forward, or sideways in a horizontal or semi-horizontal direction. The TRCPs 26 can be loaded and/or stored in vertical stacks, horizontal rows, or both in the APD 28.

Referring to FIGS. 1 and 5, the communications network 24 can be configured to provide a self-forming and self-healing mobile ad hoc network (MANET) or mesh network. In other words, the components (control unit 29, TRV 22, and TRCPs 26) can communicate with any of the other components in the network, as needed, to maintain an adequate signal between the control unit and the TRV. FIG. 6 shows only some of the possible different self-formed signal routes that may be achieved within a representative network 24 to establish and maintain communication. The system 20 and network 24 can self-form and self-heal, as needed, to provide adequate signal strength and bandwidth and to bypass failed, malfunctioning, or signal deprived TRCPs 26. The network 24 includes a head end controller 29 or control unit manned by an operator. The network 24 also includes a TRV 22 that is remotely operated by the operator via the control unit 29. As the TRV 22 and control unit 29 become separated by distance and are faced with signal obstructions, the network 24 further includes one or more of the deployed TRCPs 26, ejected as and where needed, to establish and maintain communication between the TRV and the control unit.

The network 24 can be configured to deliver 600 MBPS, in one example, to allow high-definition video, data, voice, and other electronic transmission. The network 24 can be secure and encrypted. In one example, the network 24 can be configured using CTR-AES-256 Encryption, HMAC-SHA-256 Authentication & Integrity+Utilizes Suite-B Algorithms+Cryptographically authenticated Over-the-Air Rekey and Key Zero.

The network 24, which may be identified as a secure MANET radio system for signal deprived areas (SMRSSDA), can be configured to provide reliable communication in signal deprived areas such as caves, tunnels, bunkers, ships, and the like. The network 24 can be relatively low cost, secure, high band width, rapidly deployable, modularly expandable, and easy to operate. The TRCPs 26 can be small, lightweight, and expendable devices. The TRCPs 26 can be configured to be manually or automatically destroyed or to self-destruct. The on-board electronics can be erased, fried, burned, and/or exploded upon expiration or depletion of power or through manual communication from the control unit 29.

The SMRSSDA network 24 can be seamlessly and easily employed in the field. As operators encounter signal deprived areas, they can simply drop a TRCP 26 into place using the TRV 22, or manually if moving within such an area. The network 24 then instantly forms or reforms. This links the tethered SMRSSDA worn or controlled by an operator to the rest of the network 24. An existing network may be linked to a remote field TRV 22 and TRCPs 26 in this manner as well. Operators can continue to add to and expand the network 24 as the environment dictates by deploying TRCPs 26 as needed. Upon completion of a mission, the operators may collect deployed TRCPS 26, if desired and if able, for future use. Alternatively, the operators can send a “zero” command to the deployed TRCPs 26, and the TRV 22, if needed, leaving the units, components, and devices purged of all encryption and software and rendering them essentially useless. Alternatively, the operators can send a “burn” command, which can both “zero” the selected units, components, and devices and physically destroy them in place.

In one example, the disclosed system 20 incorporates a SNR algorithm or monitoring program. The Tunnel Rat system's SNR can be coupled with a monitoring system to maintain and optimize signal quality back to the head end controller 29 or control unit. The TRV 22 can include on-board software that monitors the signal strength and/or bandwidth or SNR in real time. When the TRV 22 determines that the signal strength and/or bandwidth has dropped to or below a predetermined level, i.e., a signal strength and/or bandwidth minimum threshold, the TRV and/or the APD 28 will automatically drop a wireless communication device, i.e., a TRCP 26. The TRCPs 26 are configured and designed to boost signal strength and/or bandwidth through point-to-point line of sight communication between system components. This allows the TRV 22 to penetrate extreme distances through signal deprived environments without loss of the control signaling and electronic and RF communication between the control unit 29 and the TRV.

In another example, the TRCP concept can be used in other applications as well. The TRCPs 26 may be used separately from the Tunnel Rat system 20. The TRCPs 26 may be carried by personnel to create a highly effective Intra-Soldier Wireless (warfighter worn) communications backbone device or network. The warfighter worn system transfers all the advantages and capabilities of the disclosed network directly to the warfighter and can include Access Point and Bluetooth communication. The network will again seamlessly and automatically heal itself and expand as personnel move in and out of the network. The warfighter worn system can thus provide a dynamic and responsive communications network for all intra-soldier wireless devices.

Additionally, the disclosed TRCPs 26 may be integrated with any type of sensor to provide remote networked detection and assessment capabilities. The disclosed TRCPs 26 and APD 28 create a safe and reliable network where the TRCPs may be expendable, provide secure communication, operate at high band widths, are rapidly deployable, may be warfighter wearable, may be intra-soldier wireless compatible, operate at low power, are small, and are lightweight. The TRCPs 26 also allow a field communication system to be modularly expandable, self-healing, and function as a MANET or mesh network.

Referring to FIG. 6, the disclosed system and apparatus can be used to perform a unique method of establishing, extending, and/or maintaining a communications network 24. In this example, the TRV 22 and the main controller 29 are deployed in a potentially signal deprived area or environment. The TRV 22 is operated using the controller 29 to move about the area or environment (S100). The communication signal or signals between the TRV 22 and the main controller 29 are monitored, such as for signal strength, quality or the like. The monitored signal can be compared to a threshold value, such as a signal strength threshold (S200). The comparison can be manual, by the operator, or can be automatic, programmed as part of the system function for continuous automated monitoring. If the signal strength, quality, or the like is adequate, the operator can continue to operate the TRV 22 within the signal deprived area or environment (S300—NO).

If the signal strength, quality, or the like reaches, i.e., equals, or falls below the threshold value (S300—YES), the system can eject or dispense a TRCP 26 at the present location of the TRV 22 (S400). The ADP 28 can be operated manually and remotely by the operator from the main controller 29. Alternatively, the ADP 28, the controller 29, the TRV 22, or a combination thereof can be configured to operate automatically upon determining that the threshold value requirement has been met. Again, the TRV electronics, the ADP electronics, the controller electronics, or a combination thereof, may be configured and/or programmed to monitor the signal characteristics and to automatically eject and deploy a TRCP 26 when determined desirable to maintain communications between the TRV and the main controller.

Further, signal strength or signal quality is not intended to limit the threshold value to any particular signal characteristic. Instead, the system may monitor any signal transmitted to, from, or between the main controller and the TRV and determine, based on a characteristic of that signal, that the signal falls below the threshold value or level. The system can monitor any one or more of the different signals, including audio, video, sensor, or other signals from the TRV and make the determination to eject a TRCP based on that signal or any one of those monitored signals falling below the threshold value or level.

The disclosed apparatus, system, and method provide radio-controlled vehicles or units (TRVs) to inspect caves, tunnels, bunkers, ships, and other dangerous, high-risk, and/or signal deprived environments without exposing operators to dangerous situations. The disclosed apparatus, system, and method eliminate the need for physical tethers between system components and alleviate the typical RF communication range and strength shortcomings. The disclosed apparatus, system, and method utilize a dispensing device to selectively deploy wireless communication devices where needed to provide point-to-point communication nodes to extend the communication range of a TRV and network.

The disclosed apparatus, system, and method utilize wireless communication devices that can be automatically actuated when deployed. The devices can allow an operator to create a communications network with self-healing capabilities. The disclosed apparatus, system, and method can utilize a unique software solution to monitor signal data via either (or in any combination) monitoring radio signal strength or Radio Signal Strength Indicator (RSSI), signal bandwidth, and/or Signal-to-Noise Ratio (SNR). The system can use the acquired signal data to automatically dispense the wireless communication devices, as needed, based upon signal strength and/or quality and software parameters to assure uninterrupted communication with the control unit and between the robotic vehicle or unit and the control unit.

The disclosed apparatus, system, and method can include two-way RF data communications. The communications can allow an operator to activate lights, cameras, audio systems, microphones, sensors, and other associated devices on a TRV. The disclosed apparatus, system, and method can be utilized via two-way voice or audio communication signals to allow an operator to interrogate and instruct personnel encountered by the TRV or radio-controlled vehicle or unit during a mission.

The main controller 29 can be any type of computer or other electronic device that can be operated by a user to control the TRV, as well as other aspects of the system and/or the network. The main controller 29 may include a memory, a hard drive, a processor, and the like, and may be connected to a network that includes the same, and/or a server, and/or the like. The main controller is not limited to any specific type of electronic device or mechanism.

Although certain apparatuses, systems, and methods have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. An apparatus for establishing a communications network, the apparatus comprising:
a remote-control vehicle configured for wireless communication; and
a plurality of wireless communication devices carried by a part of the remote-control vehicle,
wherein the remote-control vehicle is configured to selectively eject or dispense the plurality of communication devices as deployed devices within a signal deprived environment,
wherein each deployed device is capable of wireless communication with the remote-control vehicle and with one or more other of the deployed devices, and
wherein each deployed device of the plurality of wireless communication devices and the remote-control vehicle is configured to define a part of the communicate network with a control unit disposed at a distance from the remote-control vehicle.

2. The apparatus of claim 1, further comprising:
a dispensing device on the remote-control vehicle, the dispensing device configured to hold and/or selectively eject or dispense the plurality of wireless communication devices.

3. The apparatus of claim 2, wherein the remote-control vehicle or the dispensing device includes a magazine holding the plurality of wireless communication devices.

4. The apparatus of claim 3, wherein a spent magazine can be replaced on the remote-control vehicle with a loaded magazine.

5. The apparatus of claim 3, wherein a spent magazine can be reloaded on the remote-control vehicle with a plurality of wireless communication devices.

6. The apparatus of claim 1, wherein the remote-control vehicle is equipped with one or more of video communication capability, audio communication capability, sensor capability, light emitting capability, and/or infra-red illumination or video capability.

7. The system of claim 1, wherein each deployed device of the plurality of wireless communication devices automatically activates when ejected or dispensed from the remote-control vehicle.

8. A system for establishing and maintaining a communications network, the system comprising:
a control unit operated from a base location in or near a signal deprived environment;
a remote-control vehicle operable by wireless communication with the control unit within the signal deprived environment; and
a plurality of wireless communication devices carried by a part of the emote-control vehicle,
wherein each of the plurality of wireless communication devices can be selectively ejected or dispensed as a deployed device within the signal deprived environment from the remote-control vehicle through wireless communication with the control unit, and
wherein the communications network is established and/or maintained between the control unit and the remote-control vehicle through any one or more of the deployed devices of the plurality of wireless communication devices.

9. The system of claim 8, wherein each of the deployed devices of the plurality of wireless communication devices automatically activates when ejected or dispensed from the remote-control vehicle.

10. The system of claim 8, further comprising:
a dispensing device on the remote-control vehicle, the dispensing device configured to hold and/or selectively eject or dispense the plurality of wireless communication devices.

11. The system of claim 10, wherein the remote-control vehicle or the dispensing device includes a magazine holding the plurality of wireless communication devices.

12. The system of claim 11, wherein a spent magazine can be replaced on the remote-control vehicle with a loaded magazine.

13. The system of claim 11, wherein a spent magazine can be reloaded on the remote-control vehicle with a plurality of wireless communication devices.

14. The system of claim 8, wherein the remote-control vehicle is equipped with one or more of video communication capability, audio communication capability, sensor capability, light emitting capability, and/or infra-red illumination or video capability.

15. The system of claim 8, wherein the remote-control vehicle is configured to eject or dispense one of the wireless communication devices before or when it is detected that a signal between the control unit and the remote-control vehicle falls to or below a minimum signal strength threshold.

16. The system of claim 8, wherein the signal reduction is determined based on monitoring Signal-to-Noise Ratio (SNR), signal strength, signal bandwidth, Radio Signal Strength Indicator (RSSI), or any combination thereof.

17. A method for establishing and maintaining a communications network, the method comprising:
operating, from a control unit, a remote-control vehicle or unit, into a signal deprived environment;
monitoring signal strength between the control unit and the remote-control vehicle or unit;
before or upon detection of a signal reduction to or below a minimum signal strength threshold, ejecting or dispensing, by the remote-control vehicle, a wireless communication device within the signal deprived environment; and
further operating the remote-control vehicle or unit into the signal deprived environment.

18. The method of claim 17, further comprising:
repeating, one or more times, the steps of monitoring, ejecting or dispensing, and further operating.

19. The method of claim 17, wherein the signal reduction is determined based on monitoring Signal-to-Noise Ratio (SNR), signal strength, signal bandwidth, Radio Signal Strength Indicator (RSSI), or any combination thereof.
